(19) United States
(12) Patent Application Publication
(10) Pub. No.: US 2016/0098136 A1
(43) Pub. Date: Apr. 7, 2016

(54) KEYLESS ENTRY SYSTEM

(71) Applicant: Ford Global Technologies, Dearborn, MI (US)

(72) Inventors: Harry Lobo, Canton, MI (US); Jessica Smith, Roseville, MI (US); Paul Kenneth Dellock, Northville, MI (US); Stuart C. Salter, White Lake, MI (US); Pietro Buttolo, Dearborn Heights, MI (US); Kassandra Ritter, Ann Arbor, MI (US)

(21) Appl. No.: 14/506,665

(22) Filed: Oct. 5, 2014

(51) Int. Cl. G06F 3/041; B60R 25/23; G06F 3/0354; G06F 3/044; G06F 3/045

(52) U.S. Cl. CPC G06F 3/0416; G06F 3/0412; G06F 3/044; G06F 3/045; G06F 3/03547; G06F 3/03548; B60R 25/23; G06F 2203/04101; G06F 2203/04111; G06F 2203/04105

(57) ABSTRACT

A keyless entry system having a single entry point display coupled to a processor that generates one or more characters to be displayed. The processor accepts an entry at the single entry point and initiates a task associated with the entry. An indicator at the display provides feedback to a user that the entry has been selected and accepted by the processor. An input mechanism at the display may also encompass a control point to control the character displayed at the single entry point display.

### TECHNICAL FIELD

The inventive subject matter is directed to a keyless entry system and more particularly to a system which permits an operator access to a locked vehicle without an ignition key while maintaining security for the vehicle.

### BACKGROUND

Vehicles have been equipped with electrical systems that allow a user having knowledge of a predetermined combination to enter that combination into an electronic keypad located outside of the vehicle to gain access to the vehicle for functions such as unlocking doors, unlocking windows, opening roof tops, opening lift gates or trunk lids, etc. Known systems are keypads having a plurality of entry points. The keypads are typically mounted externally on the vehicle to allow the user to enter a predetermined access code using the entry points. These particular systems are known to leave the vehicle susceptible to theft. Also, keypads having multiple entry points are known to be unreliable causing warranty issues and are sometimes difficult to use leaving users frustrated. All of these problems may result in overall customer dissatisfaction with the vehicle.

Vehicle security is an important feature and with existing keyless entry systems, an observer may see the access code as it is being entered by a user, or dust the keypad for user fingerprints, in order to determine the entry points being used in a combination of characters that make up the access code entered by the user. Furthermore, the plurality of entry points in current keyless entry systems require a packaging area, typically near the driver side door handle or B-pillar. Because multiple entry points must lit into the packaging area, the size of the packaging area requires a small receiving area for each entry point so that multiple entry points fit in the area. Therefore, when entering an access code, the user has only a small area in which to make a selection, using their finger, and may have a difficult time entering the combination of characters that make up the access code. Multiple attempts may be necessary for the correct code to be entered by the user. Also, known keyless entry systems lack feedback for the user to let them know when each digit of their access code has been received for consideration by the keyless entry system. Again, multiple attempts may be necessary for the correct code to be entered by the user.

There is a need for a keyless entry system that keeps the vehicle secure and eases the difficulties experienced by a user when gaining keyless access to the vehicle by way of the keyless entry system.

### SUMMARY

A keyless entry system having as single entry point display coupled to a processor that generates one or more characters to be displayed. The processor accepts an entry at the single entry point and initiates a task associated with the entry. An indicator at the display provides feedback to a user that the entry has been selected and accepted by the processor. An input mechanism at the display may also encompass as control point to control the character displayed at the single entry point on the display.

### DESCRIPTION OF DRAWINGS

FIG. 1 is a partial view of as vehicle equipped with a keyless entry system;

FIG. 2A is an exploded diagram showing a receiving area of the single entry point keypad system;

FIG. 2B is a diagram showing the circuitry of the receiving area of the single entry point keypad system;

FIG. 3 is a diagram of a single entry point keypad system having an adjuster for controlling a character to be displayed; and

FIG. 4 is a diagram of a single entry point keypad system having an adjuster slider control point for controlling a character to be displayed.

Elements and steps in the figures are illustrated for simplicity and clarity and have not necessarily been rendered according to any particular sequence. For example, steps that may be performed concurrently or in different order are illustrated in the figures to help to improve understanding of embodiments of the inventive subject matter.

### DESCRIPTION OF INVENTION

While various aspects of the inventive subject matter are described with reference to a particular illustrative embodiment, the invention is not limited to such embodiments, and additional modifications, applications, and embodiments may be implemented without departing from the inventive subject matter. In the figures, like reference numbers will be used to illustrate the same components. Those skilled in the at will recognize that the various components set forth herein may be altered without varying from the scope of the inventive subject matter.

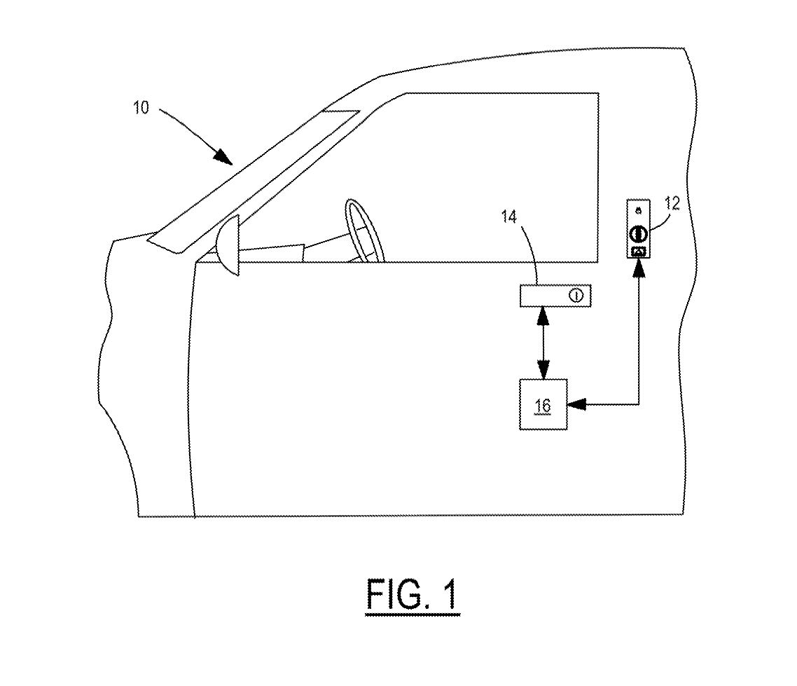

FIG. 1 is a partial view of a vehicle 10 equipped with a keyless entry system 12. The keyless entry system 12 is shown to be in proximity to a lock system 14 of the vehicle 10. The keyless entry system 12 is shown on the B-pillar of a driver side door of the vehicle 10 but may, additionally or alternatively, be installed on another location, or multiple locations, on the vehicle without departing from the scope of the ins subject matter. For example, the keyless entry system may be located on a door, such as a driver's side or passenger side door, or a door handle. A processor 16, or an electronic control module, is connected to the keyless entry system 12 and is capable of generating characters to be displayed at the keyless entry system, accepting inputs from the keyless entry system and initiating actions that enable vehicle access such as, but not limited to, the lock system 14 for one or more doors of the vehicle, one or more vehicle windows, a vehicle lift gate or trunk, and a vehicle roof to name just a few.

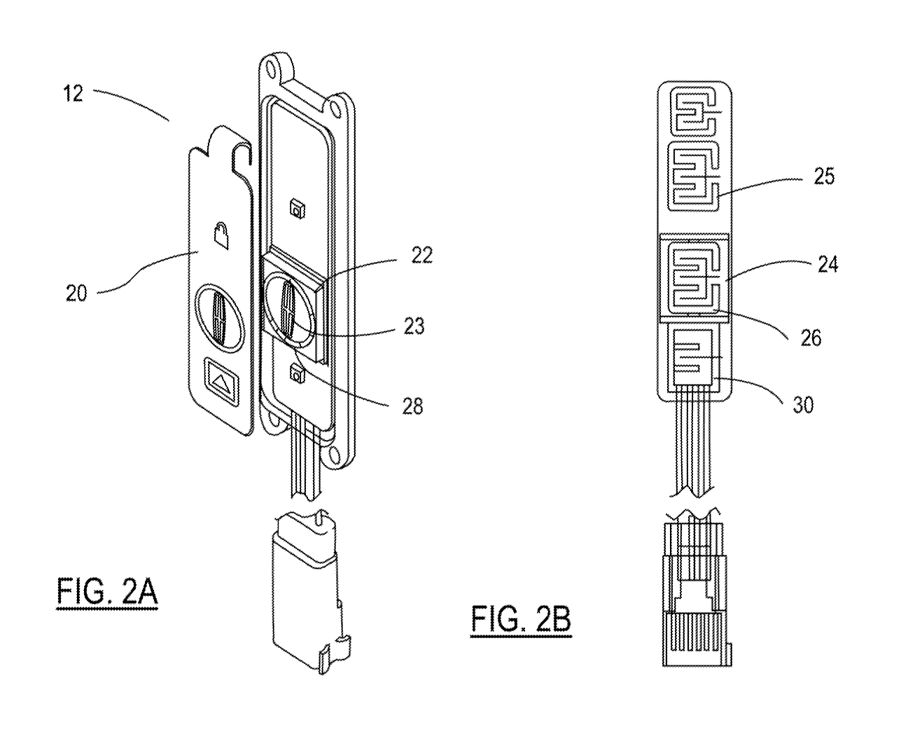

Referring now to FIG. 2A, an exploded front view of the single entry point keyless entry system 12 is shown. The system 12 has a trim member 20 that covers a display 22. The trim member may be transparent, or translucent. The display 22 may be illuminated to display a character 23 to a user so that the character is visible through the trim member 20. The processor 16 (not shown in FIG. 2A) communicates with the display 22 to determine the character 23 that is displayed, accepts inputs from the display and may provide feedback to a user. The processor 16 also initiates access functions. Therefore, the processor 16 also communicates with the lock system 14 of the vehicle.

Referring now to FIG. 2B, a diagram of the circuitry for the keyless entry system 12 is shown. A single entry point 24 is as sensor or switch in communication with the display 22 so that as a character is displayed, the user may enter, i.e., select and communicate, the character that is part of a predetermined access code, using the single entry point 24, to he considered by the processor 16. The single entry point 24 may be a proximity sensor that is typically a printed circuit board and has a receiving area 26 that may be a capacitive, resistive, or other type of switch that allows the user to select the character. The single entry point 24 is in communication with the processor so the processor 16 may receive and consider the character entered from the single entry point 24 as it is selected at the display 22. In the embodiment shown the circuitry for the single entry point may be located on a backside of the trim member 20 as shown in FIG. 2B.

The printed circuit board of the single entry point 24 may include a rigid printed circuit, a flexible printed circuit, a conductive ink, or other suitable material. The single entry point 24 may transparent, or translucent, to allow as view of the illuminated display and the receiving area 26 generally surrounds and encompasses an area that coincides with the display 22.

For operation of the keyless entry system 12, the user has a predetermined access code, which is a subset of the plurality of characters entered at the display having a predetermined sequence. Each character in the plurality of characters 23 will be displayed one at a time at the display 22 of the keyless entry system 12. The processor 16 generates a character to be displayed at the display 22 and the user will push the single entry point 24 when a desired character from the subset of characters is displayed in the proper predetermined sequence thereby selecting the character and entering the character at the processor for consideration. In one embodiment of the inventive subject matter, the characters 23 are displayed one character at a time in a predetermined order and at a predetermined interval. The user has a predetermined amount of time to select a character 23 before the processor 16 cycles to the next character to be displayed at the display 22. As discussed above, selection of a character is made by pushing the single entry point 24. In the event the user fails to select as character, the display may cycle through the characters to display each character again and the user may select the character during a subsequent cycle. In another embodiment of the inventive subject matter, upon activation, the processor 16 may randomly generate the first character 23 to be displayed to further reduce the probability that an observer may observe an order of the entries or count entries made by a user to learn the code and gain access to the vehicle. If the user fails to make a selection at all, or if an incorrect access code is entered, the display will time out and resort to a resting or sleep mode.

The processor 16 will cycle through the available characters one or more times at the display giving opportunity tot tile user to enter each character of a predetermined access code that is considered and either accepted or rejected by the processor 16. If the access code is rejected, the user cannot gain access to the vehicle. If the access code is accepted, the user may elect to control the vehicle so as to unlock one or more doors, a lift gate, a trunk, and/or open or close a window, roof, lift gate or trunk on the vehicle, also using the entry point 24 to communicate with the processor 16 and the lock system 14. To lock the vehicle, the keyless entry system 12 has a lock control point 25 that, when pressed, indicates to the processor 16 to initiate locking of the vehicle 10 by way of the locking system 14.

Referring still to FIGS. 2A and 2B, the display 22 has an indicator 28 that provides feedback to the user that a character has been selected and considered by the processor. The indicator shown in FIG. 2A is one or more segments on the display that are illuminated, one segment at a time, to indicate to the user that a character has been selected and entered as each character in the code is selected and entered by the user. One or more segments may illuminate to indicate to a user whether the characters entered match the predetermined access code. For example, one segment illuminates for each character that is entered by the user. In another embodiment the illuminated segments may be a color, such as red or green to indicate that the complete code has been entered and either accepted or rejected by the processor 16. The segments may also illuminate a particular color thereby indicating a correct or incorrect entry. For example, for an acceptable entry, the indicator may illuminate green and for an unacceptable entry, the indicator may illuminate red. There may be more than one segment whereby the number of segments corresponds to the number of characters in the predetermined access code.

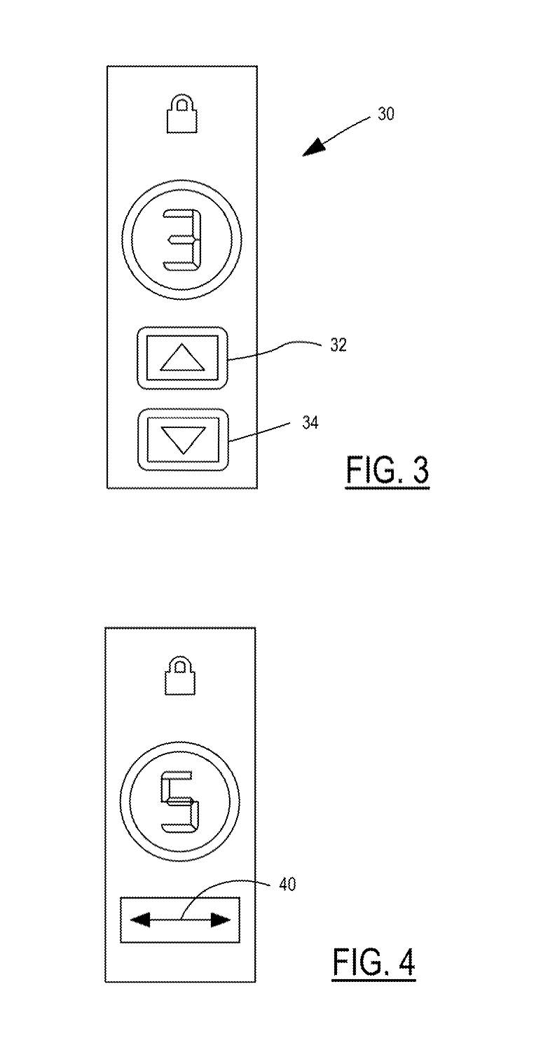

FIG. 3 is diagram of another embodiment of the inventive subject matter that includes an adjuster 30 for the user to determine the character 23 that is displayed at the display 22. The adjuster 30 may be one or more arrow control points 32, 34 that allow a user to control the cycle of the characters generated by the processor and displayed at the display 22. For example, when the characters are numerical, an up arrow control point 32 will increase the digit by one and a down arrow control point. 34 will decrease the digit by one. The adjuster 30 allows the user to control the characters being displayed and allows faster and more efficient selection of each character in the access code. Upon display of the desired character 23, the user will push the single entry point 24 to communicate the selection to the processor.

FIG. 4 is another example of an adjuster in the form of a slider control point 40. In operation, again using numerical digits an example, the user may slide their finger along the slider control point 40 in a first direction to increase the character and slide their finger along the control point in as second direction, opposite the first direction, to decrease the character displayed at the display. Upon display of the desired character 23, user will push the single entry point 24 to communicate the selection to the processor 16. The slider, while shown in a horizontal configuration in FIG. 4, may also positioned in other configurations, such as vertical.

The display 22 and single entry point 24 of the inventive subject matter are advantageous in that only a single character at a time is being displayed and only one entry point is being used to enter and communicate the character. Because only one character at a time is displayed, the size of the display, entry point and receiving area may be enlarged from known systems that provide multiple entry points and characters simultaneously, thereby making it easier for the user to enter their selection. Because the user is repeatedly pushing only a single entry point as the characters cycle through the display, the inventive subject matter also eliminates the possibility of dusting several entry points for fingerprints to determine which entry points are being used when entering the access code. The random generation of a starting character or each character likewise enhances security by preventing an observer from observing and counting the number of characters that pass between a user's selection at the display in an attempt to figure out the predetermined subset of characters that initiate access to the vehicle.

In the foregoing specification, the invention has been described with reference to example embodiments. Various modifications and changes may be made, however, without departing from the scope of the inventive subject matter as set forth in the claims. The specification and figures are illustrative, rather than restrictive, and modifications are intended to be included within the scope of the inventive subject matter. Accordingly, the scope of the invention should be determined by the claims and their legal equivalents rather than by merely the examples described.

For example, the steps recited in any method or process claims may be executed in any order and are not limited to the specific order presented in the claims. The system be implemented with a filter to minimize effects of signal noises. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

The terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the inventive subject matter, in addition to those not specifically recited, may be varied or otherwise particularly adapted to specific environments, manufacturing specifications, design parameters or other operating requirements without departing from the general principles of the same.

1. A keyless entry system comprising:
a display having a single entry point;
a processor for generating a plurality of characters and individually displaying each character, the single entry point for selecting each character of a predetermined subset of characters from the plurality of characters displayed at the display;
a sliding adjuster mechanism in communication with the processor for determining a character to be displayed; and
the processor accepts each entry and initiates a task associated with the predetermined subset of characters.

2. The system as claimed in claim 1 wherein the display further comprises an indicator for providing feedback that the character has been selected and accepted by the processor.

3. (canceled)

4. (canceled)

5. (canceled)

6. (canceled)

7. (canceled)

8. (canceled)

9. (canceled)

10. (canceled)

11. The system as claimed in claim 1 wherein a first character of the plurality of characters displayed is randomly generated h the processor and characters are cyclically displayed in a predetermined sequence generated by the processor.

12. The system as claimed in claim 1 wherein the display further comprises at least one capacitive pad.

13. The system as claimed in claim 1 wherein the display further comprises at least one resistive pad.

14. The system as claimed in claim 1 wherein the display further comprises a conductive ink.

15. A keyless entry system for use on a vehicle comprising:
a door mounted display having a single entry point and an indicator;
a processor for generating a plurality of characters and individually displaying each character, the single entry point for selecting each character of a predetermined subset of characters from the plurality of characters displayed at the display, the indicator for indicating a character has been selected;
a sliding adjuster mechanism in communication with the processor for determining the character to be displayed; and
the processor accepts each entry and initiates a task associated with the predetermined subset of characters.

16. (canceled)

17. The system as claimed in claim 15 wherein the door mounted display is on a driver side door of the vehicle.

18. The system as claimed in claim 15 further comprising a door mounted display on a passenger side of the vehicle.

19. (canceled)

20. (canceled)

21. (canceled)

22. The system as claimed in claim 15 wherein a first character of the plurality of characters displayed is randomly generated by the processor and characters are cyclically displayed in a predetermined sequence generated by the processor.

23. The system as claimed in claim 15 wherein the display further comprises at least one capacitive pad.

24. The system as claimed in claim 15 wherein the display further comprises at least one resistive pad.

25. The system as claimed in claim 15 wherein the display further comprises a conductive ink.

26. A keyless entry system for a vehicle comprising:
a trim member;
an input mechanism positioned behind the trim member;
a display positioned behind the input mechanism and displaying a character that is visible through the input entry point and the trim member;
a processor in communication with the input mechanism, the display and a lock system of the vehicle, the processor for generating character to be displayed at the display and initiating a function that enables access to the vehicle; and
a sliding adjuster mechanism to communicate to the processor a particular character to be displayed at the display and selected at the input mechanism.

27. The keyless entry system as claimed in claim 26 wherein the display further comprises an indicator and wherein the processor initiates illumination of the indicator when a character has been selected at the input mechanism.

28. (canceled)

29. (canceled)

30. (canceled)

31. The keyless entry system as claimed in claim 26 wherein the input mechanism further comprises a lock input mechanism to communicate a command to the processor to disable access to the vehicle.

32. The keyless entry system as claimed in claim 26 wherein the processor generates a plurality of characters to be displayed, one at a time, at the display.

33. The keyless entry system as claimed in claim 32 wherein the processor randomly generates a first character to be displayed and the processor generates subsequent characters to he displayed in sequential order.

34. The keyless entry system as claimed in claim 33 further comprising predetermined time interval that the processor generates and displays subsequent characters.

35. The system as claimed in claim 11 further comprising a predetermined time interval that the characters are cyclically generated by the processor and displayed at the display.

36. The system as claimed in claim 22 further comprising a predetermined time interval that the characters are cyclically generated by the processor and displayed at the display.
